(19) United States
(12) Patent Application Publication
(10) Pub. No.: US 2008/0213708 A1
(43) Pub. Date: Sep. 4, 2008

(54) Fuel Delivering Terminal For a Combustion Lance of Lime Regenerating Ovens, Combustion Lance Equipped With Such Terminal, System and Process For Controlling the Fuel Supply Flow Through Such Lance

(76) Inventors: Eugen Dan Cristea, Bergamo (IT); Oliviero Collarini, Basiglio (IT)

Correspondence Address: SHELDON MAK ROSE & ANDERSON PC, 100 Corson Street, Third Floor, PASADENA, CA, 91103-3842, US

(21) Appl. No.: 11/908,604

(22) PCT Filed: Feb. 10, 2006
(86) PCT No.: PCT/IT2006/000069

§ 371 Date: Sep. 13, 2007

(30) Foreign Application Priority Data
Mar. 29, 2005 (IT) TO2005A000204

(51) Int. Cl. F23D 1/00; F27B 1/00

(52) U.S. Cl. 431/7; 431/12; 432/96; 432/164; 432/37; 431/75

(57) ABSTRACT

A fuel delivering terminal (1) is disclosed adapted to be connected to a delivery end of a combustion lance (3) of lime regenerating ovens, wherein D is the external diameter of the terminal (1) and is greater that the internal diameter d of the delivery end of the combustion lance (3); a combustion lance equipped with the terminal (1) and a system and a process for controlling the fuel supply flow through such lances are also disclosed.

The present invention refers to a fuel delivering terminal for a combustion lance of lime regenerating ovens and to a lance equipped with such terminal. The present invention further refers to a system and a process for controlling the fuel supply flow through such lance.

As known, parallel-flow regenerating ovens for producing lime from limestone are composed of two vats, which are mutually interconnected through a connection channel.

Limestone is loaded in every vat and descends along the pre-heating area, in which the regenerating heat exchange occurs as counter-current with fumes, and arrives into the cooking/calcining area.

The oven operation provides the alternate combustion in every vat with a combustion cycle, which is 8-12 minutes long.

In the first step of the combustion cycle, fuel is entered through combustion lances into the vat under combustion and burns air, which is blown therein. In particular, in case of use of solid fuel, such as for example coal dust, the combustion lances insert fuel entrained by transport air into the vat under combustion. The freed heat is partly absorbed by limestone calcining in the first vat. Simultaneously, cooling air is entered at the base of each vat in order to cool lime. The cooling air of the vat under combustion, together with combustion gases and carbon dioxide freed from limestone when calcining, moves along the interconnected transverse channel, thereby reaching the second vat at the temperature of about 1050° C. In the second vat, gases coming from the first vat are mixed with cooling air at the base of the second vat and rise, thereby heating limestone which can be found in the second vat pre-heating area.

Should the above described operating mode go on, the exhaust gas temperature would well exceed 300° C. Therefore, after a period of 8-12 minutes, the fuel and air flows to the first vat initially under combustion are stopped, vats are depressurised, lime is discharged, vats are recharged with fresh limestone and the process is reversed; in traditional ovens, it is important not to exceed the combustion cycle by 12 minutes, in order to avoid an overheating and the possible consequent lime over-cooking. After having charged the limestone, fuel and air are supplied to the second vat and exhaust gases are expelled from the top part of the first vat towards a sleeve filter in order to decrease solid particulates before its scavenging into the atmosphere/environment.

In traditional regenerating ovens, the operating life of combustion lances is limited, even if the oven always correctly operates. In particular, life of a combustion lance depends on the type of steel of which it is made, on the type of fuel, on the limestone calcining behaviour and on oven operating conditions. From experiences, the typical life of a lance is 1-2 years, but it can be much shorter in case of oven operating problems, internal limestone blocks formation and fuel overheating.

In particular, in case of coal dust, one of the typical situations, which generate a quick consumption of the combustion lances, and a drastic decrease of their operating life, is the one deriving from the space distribution modes of limestone grains around the lance delivering nozzle. Not infrequently, in fact, in traditional lances, one of more limestone grains can become arranged, when charging the vat, extremely near if not as occluding the delivering nozzle. In such context, the combustion of the coal dust delivered by the lance occurs immediately near the delivering nozzle, causing its quick and unavoidable deterioration, which generates consumption, shortening and consequent necessary replacement of the whole lance, with the obvious waste of economic resources and time which such operation produces. For the above reasons, it is obvious that, in order to be able to always guarantee a correct and continuous operation of the oven, it is necessary, if not advisable, to always have available complete sets of spare lances, with related storage costs and problems.

For the correct operation of the regenerating oven, it is further extremely important to be able to measure and control the temperature of gas flowing through the transverse channel between the two vats. Currently, however, the art does not propose systems and processes which regulate such temperature by interacting with the combustion lances to generate a reduction or interruption of fuel delivery in case the temperature of gases in transit exceeds the set threshold values.

Therefore, object of the present invention is solving the above prior art problems by providing a fuel delivering terminal for combustion lances which greatly increases their operating life with respect to known combustion lances.

Another object of the present invention is providing a combustion lance equipped with a fuel delivering terminal having a greatly longer operating life with respect to known combustion lances.

A further object of the present invention is providing a system and a process for controlling the fuel supply flow through said lances which allows increasing operating efficiency, safety and reliability of a lime regenerating oven.

The above and other objects and advantages of the invention, as will appear from the following description, are reached by a fuel delivering terminal for a combustion lance of lime regenerating ovens as disclosed in claim 1.

Moreover, the above and other objects and advantages of the invention are reached by a combustion lance equipped with a fuel delivering terminal as disclosed in claim 5.

The above and other objects and advantages of the invention are finally reached by a system and a process for controlling the fuel supply flow through the above combustion lances as respectively disclosed in claims 8 and 11.

Preferred embodiment and non trivial variations of the present invention are the subject matter of the dependent claims.

The present invention will be better described by some preferred embodiments thereof, provided as a non limiting example, with reference to the enclosed drawings, in which:

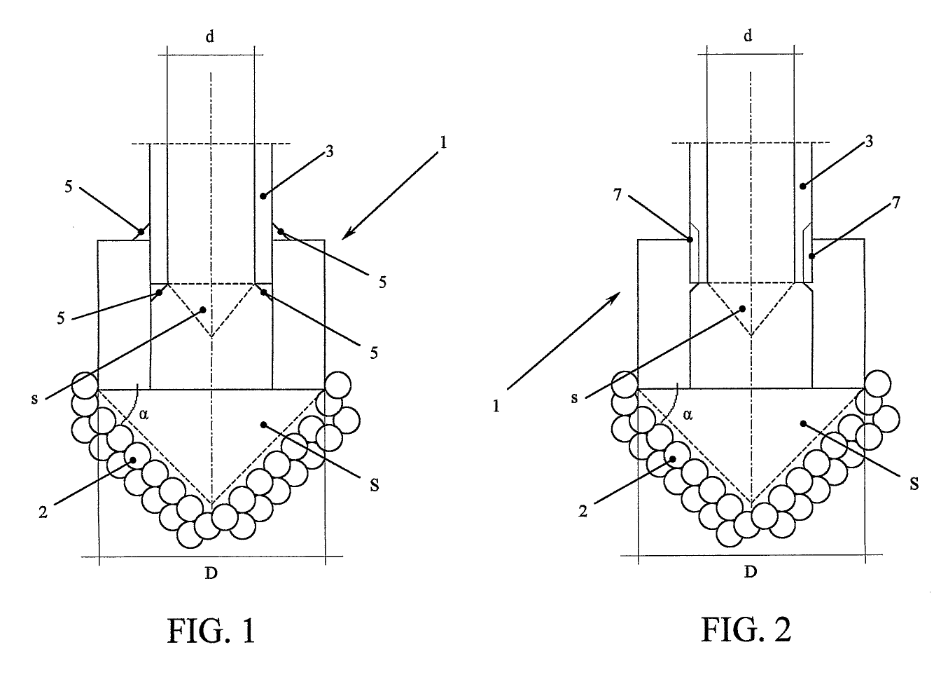

FIG. 1 shows a sectional view of an embodiment of the fuel delivering terminal for a combustion lance according to the present invention;

FIG. 2 shows a sectional view of an embodiment of the fuel delivering terminal for a combustion lance according to the present invention;

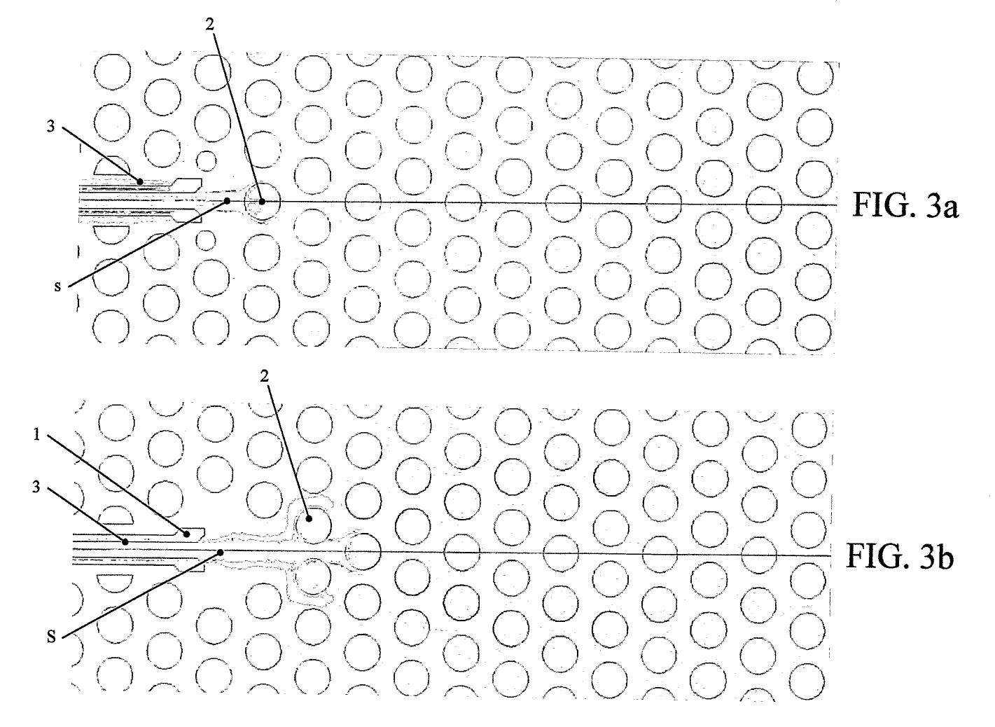

FIGS. 3a and 3b show a comparison between two thermometer diagrams respectively related to the operation of a traditional combustion lance and a combustion lance according to the present invention;

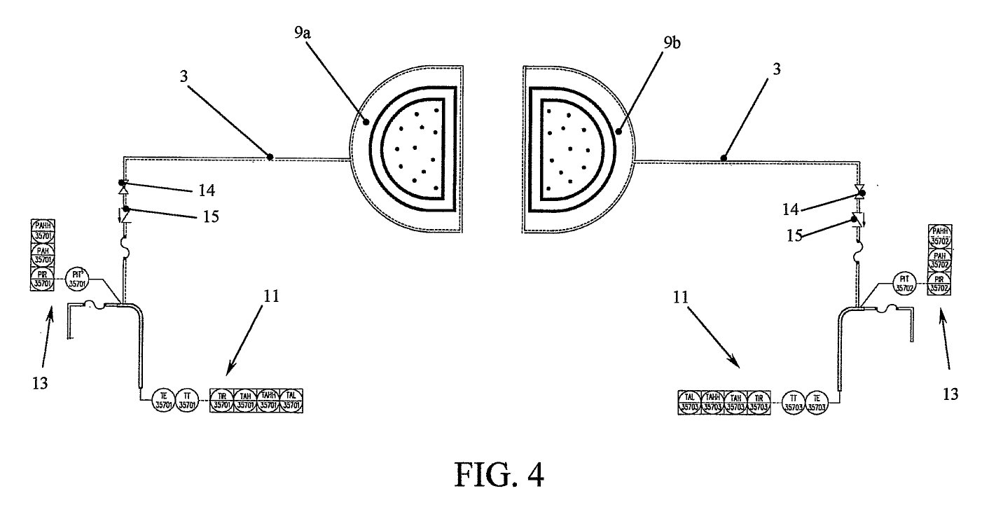

FIG. 4 shows a block diagram showing an embodiment of the system for controlling the fuel supply flow according to the present invention;

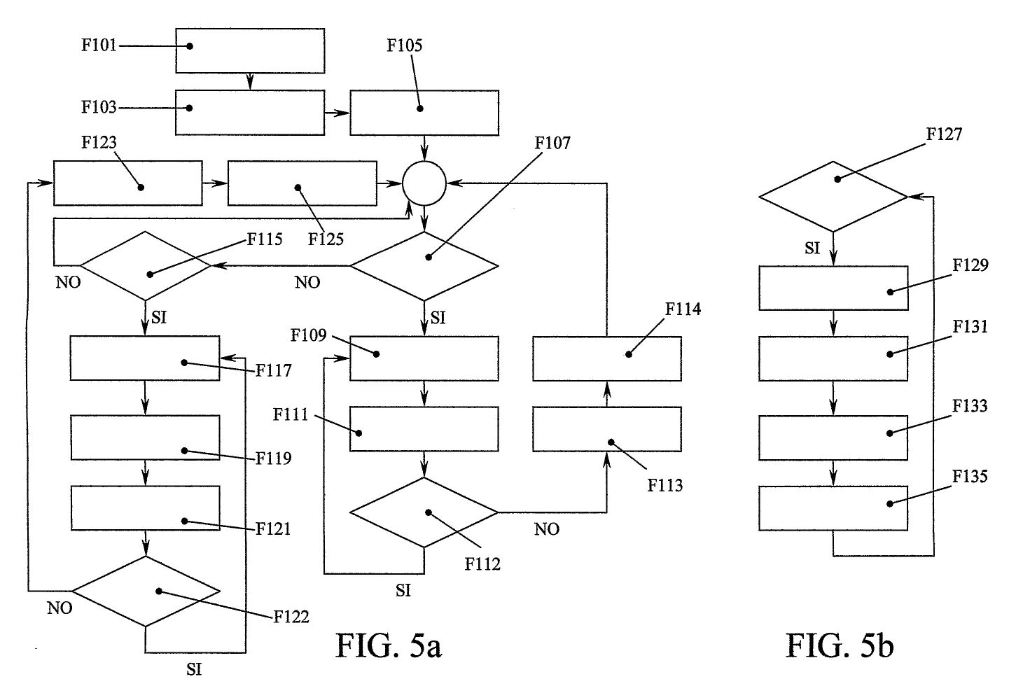

FIG. 5a shows a flow diagram showing some steps of the process for controlling the fuel supply flow;

FIG. 5b shows another flow diagram showing some steps of the process for controlling the fuel supply flow; and

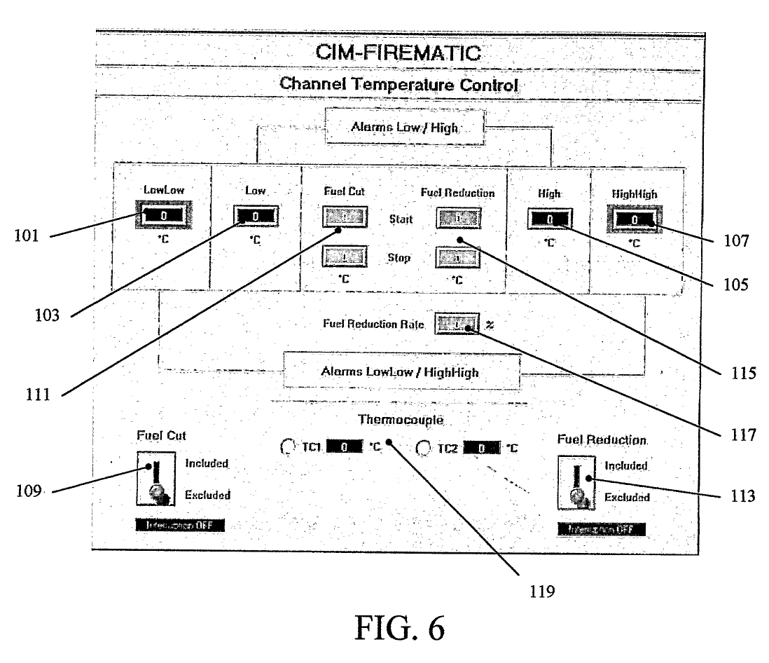

FIG. 6 shows an example of a screen produced by a computer program realising the process according to the present invention.

With reference to FIG. 1, it is possible to note a preferred embodiment of the fuel delivering terminal 1, in particular for powdery solid fuel, according to the present invention, for a combustion lance 3: the terminal 1 is substantially a tubular elongation, preferably of a cylindrical shape, coaxially connected to the delivery end of a combustion lance 3. In order to aid the fuel passage and a correct coupling with the lance 3 delivery end, the terminal 1 preferably has an internal diameter which is substantially equal to the external diameter of the delivery end of the combustion lance 3.

As can be noted from FIGS. 1 and 2, reference d designates the internal diameter of the delivery end of the combustion lance 3 and reference D designates the external diameter of the terminal 1.

Always with reference to FIGS. 1 and 2, reference s designates the empty space between limestone 2 granules which would have been generated by the delivery end of the combustion lance 3 without the terminal 1 due to the rest angle which is characteristic of the granules themselves, and reference S designates the empty space generated by the terminal 1 connected to the combustion lance 3. The shortage of the empty space s is the aspect which generates previously described problems to traditional combustion lances; in fact, due to the reduced size of diameter d, when loading the vat, the limestone 2 granules, due to gravity and their natural slope, are arranged very near to the delivery point of the lance 3, even getting, in the most severe cases, to clog it; for such purpose, with reference to FIG. 3a, it is possible to note an experimental thermometer diagram, created with a mathematical simulation of the process by means of a commercial CFD software, related to the operation of a traditional combustion lance 3; such graph shows, with different grey tones, the temperature ranges which are generated during combustion around the fuel delivery end, the white areas being those in which the temperature is higher (on the order of 1200-1300° C.).

Instead, with reference to FIG. 3b, it is possible to note a thermometer diagram, similar to the previous one, however related to the operation of a combustion lance 3 equipped with the terminal 1: from the comparison of the two diagrams, the following considerations appear clear:

by using the terminal 1, the limestone 2 granules are arranged around the fuel delivering point leaving an empty space S which is larger than the empty space s resulting from the use of a traditional lance 3;

the empty space S allows preventing the limestone 2 granules from clogging the fuel delivering point, this latter situation, making the thermal combustion peaks approach the delivering point, impairing the operating life length of the lance 3;

the empty space S operates as combustion chamber, making the higher thermal density points moving away from the fuel delivering end.

In view of the previous considerations, the use of the terminal 1 allows obtaining an extension of the operating life of the combustion lance 3 to which it is connected, since this latter one is subjected to far less thermal stresses with respect to traditional lances; moreover, the empty space S allows making combustion easier, since the higher temperature ranges operate on a greater amount of surrounding limestone 2 granules.

In order to obtain the above described advantages, the terminal must be sized so that D>d, preferably D>>d; in particular, the temperature range diagram of FIG. 3b has been obtained by using diameters which still more preferably are in such a mutual ratio as: D/d≈8, 9, generating a basic angle a of the triangle which schematically shows the rest angle of the empty space S approximately equal to 30°.

The terminal 1 can be easily connected to the combustion lance 3, as shown in FIG. 1, through welding 5. Alternatively, it is possible to provide a threaded coupling 7 between terminal and combustion lance 3, as shown in particular in FIG. 2 or any other suitable means. The terminal 1 of the present invention can therefore be easily connected to traditional combustion lances, thereby allowing to update existing regenerating ovens.

Obviously, a combustion lance for regenerating ovens equipped with a fuel delivering terminal 1 as previously described is also the subject matter of the present invention.

From the experimental point of view, it has been detected that the most interesting results have been obtained by using as powdery solid fuel the medium/high volatile bituminous carbon dust entrained by transport air. It is however evident that the terminal and/or the combustion lance according to the present invention can advantageously be used with any other type of powdery solid fuel.

Moreover, with reference to FIG. 4 in which it is possible to note the two vats 9a, 9b of a regenerating oven, in order to allow the timely and efficient control of the combustion triggered by the combustion lance according to the present invention, it is possible to provide this latter one with at least one temperature sensor 11, such as for example a thermocouple, and possibly with at least one pressure sensor 13, such as for example a static pressure transmitter, placed next to its delivery end, which allow obtaining discrete or continuous measures of major parameters of combustion status and fumes generated therefrom.

A system for controlling the fuel supply flow through such lances is a further subject matter of the present invention; the system of the invention allows, by intervening on fuel flows delivered by combustion lances, regulating the internal temperature of the interconnection channel between the two vats of the regenerating oven. In particular, the system according to the present invention comprises:

means for detecting the temperature inside the regenerating oven vat; such detecting means can be the previously mentioned temperature sensors placed in combustion lances or a third temperature sensor (not shown) inside the channel;

means for regulating the fuel flow rate from the combustion lances; always with reference to FIG. 4, such means can be ball valves 14 and/or non-return valves 15 placed along the fuel supplying ducts serving the combustion lances;

means for acquiring and processing the measured temperature values; such means are adapted to compare measured temperature values with threshold values which are predefined or set by an external operator; if measured temperature values exceed threshold values, the acquiring and processing means operate on the flow rate regulating means in order to reduce or stop the fuel flow delivered by one or more combustion lances, taking then back the temperature values inside the interconnection channel and the vats within the allowed operating limits.

A process for controlling the fuel supply flow through the combustion lances is a further subject matter of the present invention. Such process allows regulating the supply fuel flow to regenerating oven vats in order to control the temperature of gases flowing inside the interconnection channel.

With reference to FIG. 5a, it is possible to note that the process according to the present invention comprises the steps of:

measuring (F101) the temperature value inside the interconnection channel;

defining (F103) at least one first temperature threshold value;

defining (F105) at least one second temperature threshold value, the second threshold value being lower than the first threshold value;

comparing (F107) the measured temperature value with the first threshold value;

if the measured temperature value is greater than the first threshold value, stopping (F109) the fuel supply to vats and starting (F111) a count of a stopping time period in which the fuel supply to vats is stopped;

comparing (F112) the measured temperature value with the first threshold value;

if the measured temperature value is greater than the first threshold value, repeating steps (F109) and (F111), otherwise starting again (F113) the fuel supply to vats and stopping (F114) the stopping time period count;

if the measured temperature value is less than the first threshold value, comparing (F115) the measured temperature value with the second threshold value;

if the measured temperature value is greater than the second threshold value, reducing (F117) the flow-rate F_{A} of the fuel flow supplied to vats by a preset reduction factor f_{R} obtaining a flow with reduced flow-rate F_{R} according to the relationship:

F_{R}=F_{A}×f_{R} where f_{R} is a value included between 0 and 1;

reducing (F119) the combustion air flow-rate supplied to vats;

starting (F121) a count of a reduction time period in which the fuel flow-rate to vats is reduced;

comparing (F122) the measured temperature value with the second threshold value F122;

if the measured temperature value is greater than the second threshold value, repeating steps (F117), (F119) and (F121), otherwise taking back (F123) the fuel and air flow-rates to previous values and stopping (F125) the reduction time period count.

With reference to FIG. 5b, the process according to the present invention can further comprise the steps of:

controlling (F127), at the beginning of every oven operating cycle, whether steps (F109), (F111) and/or (F117), (F119), (F121) have been performed in the previous cycle;

if the control in step (F127) has a positive result, inhibiting (F129) steps (F107) and (F115), and starting (F131) the fuel supply to vats;

controlling (F133) the amount of fuels supplied to vats; if the amount of supplied fuel is equal to the amount supplied in the previous cycle, stopping (F135) the fuel supply to vats.

The steps of the process according to the present invention shown in FIG. 5b, and as described above, advantageously allow supplying the same amount of fuel in every cycle, in such a way as not to create thermal unbalances between the two vats and to make the operation of the regenerating oven as a whole more efficient and regular.

It is clear that the present invention further refers to a computer program comprising computer program code means adapted to perform all or part of the steps of the above mentioned process when such program is run on a computer. With reference in particular to FIG. 3, it is possible to note an exemplifying embodiment of a screen of the program according to the present invention in which the following control parameters can be seen:

Temperature Low Low 101: alarm threshold for the alarm about very low temperature in interconnection channel;

Temperature Low 103: alarm threshold for the alarm about low temperature in interconnection channel;

Temperature High 105: alarm threshold for the alarm about high temperature in interconnection channel;

Temperature High High 107: alarm threshold for the alarm about very high temperature in interconnection channel;

Fuel Cut Included/Excluded 109: selector for enabling the fuel supply stopping function;

Fuel Cut Start/Stop 111: set points for starting and ending the fuel supply stop;

Fuel Reduction Included/Excluded 113: selector for enabling the fuel supply reducing function;

Fuel Reduction Start/Stop 115: set points for starting and ending the fuel supply reduction;

Fuel Reduction Rate 117: reduction factor f_{R} set for reducing the fuel supply;

Thermocouple Selection 119: selection of temperature detecting means inside the reference interconnection channel for alarms and regulating means.

1. A fuel delivering terminal adapted to be connected to a delivery end of a combustion lance of lime regenerating ovens, wherein d is an internal diameter of the delivery end of the combustion lance and D is an external diameter of the terminal, where the diameter D is greater than the diameter d.

2. The fuel delivering terminal of claim 1, where D/d≈8.9.

3. The fuel delivering terminal of claim 1, where the terminal is connected to the delivery end of the combustion lance through welding.

4. The fuel delivering terminal of claim 1, where the terminal is connected to the delivery end of the combustion lance through a threaded coupling.

5. The fuel delivering terminal of claim 1, where the terminal comprises a fuel that is in the form of a powdery solid.

6. The combustion lance for regenerating ovens comprising the terminal of claim 1.

7. The combustion lance of claim 6, further comprising at least one temperature sensor.

8. The combustion lance of claim 6, further comprising at least one pressure sensor.

9. A system for controlling a fuel supply flow through a combustion lance of lime regenerating ovens, where the system comprises:
(a) means for detecting a temperature inside at least one vat of a regenerating oven;
(b) means for regulating a fuel flow-rate delivered by the combustion lance; and
(c) means for acquiring and processing measured temperature values.

10. The system of claim 9, where the means for detecting are temperature sensors.

11. The system of claim 9, where the regulating means is selected from the group consisting of ball valves, nonreturn valves and both ball valves and nonreturn valves.

12. A process for controlling a fuel supply flow through a combustion lance of lime regenerating ovens, where the process comprises the steps of:
(a) measuring the temperature value inside an interconnection channel between vats of an oven;
(b) defining at least one first temperature threshold value;
(c) defining at least one second temperature threshold value, the second threshold value being lower than the first threshold value;
(d) comparing the measured temperature value with the first threshold value;
(e) if the measured temperature value is greater than the first threshold value, stopping the fuel supply to the vats and starting a count of a stopping time period in which the fuel supply to the vats is stopped;
(f) comparing the measured temperature value with the first threshold value;
(g) if the measured temperature value is greater than the first threshold value, repeating steps, otherwise starting again the fuel supply to the vats and stopping the stopping time period count;
(h) if the measured temperature value is less than the first threshold value, comparing the measured temperature value with the second threshold value;
(i) if the measured temperature value is greater than the second threshold value, reducing the flow-rate F_{A} of the fuel flow supplied to the vats by a preset reduction factor f_{R} obtaining a flow with reduced flow-rate F_{R} according to the relationship: F_{R}=F_{A}×f_{R} where f_{R} is a value included between 0 and 1;
(j) reducing the combustion air flow-rate supplied to the vats;
(k) starting a count of a reduction time period in which the fuel flow-rate to the vats is reduced;
(l) comparing the measured temperature value with the second threshold value; and
(m) if the measured temperature value is greater than the second threshold value, repeating steps, otherwise taking back the fuel and air flow-rates to previous values and stopping the reduction time period count.

13. The process of claim 12, further comprising the steps of:
(A) controlling, at the beginning of every oven operating cycle, whether the steps of stopping the fuel supply to the vats, starting a count of a stopping time period and/or reducing a flow-rate F_{A}, reducing a combustion air flow-rate and starting a count of a reduction time period have been performed in the previous cycle;
(B) if the control in step has a positive result, inhibiting steps, and starting the fuel supply to the vats; and
(C) controlling the amount of fuels supplied to the vats; if the amount of supplied fuel is equal to the amount supplied in the previous cycle, stopping the fuel supply to the vats.

14. A computer program comprising computer program code means adapted to perform the process of claim 12 when the program is run on a computer.

15. A computer readable medium comprising the computer program of claim 14.

16. A computer program comprising computer program code means adapted to perform the process of claim 13 when the program is run on a computer.

17. A computer readable medium comprising the computer program of claim 16.
